(19) United States
(12) Patent Application Publication
(10) Pub. No.: US 2026/0057770 A1
(43) Pub. Date: Feb. 26, 2026

(54) METHOD FOR DETERMINING PARKING OCCUPANCY WITH A UAV

(71) Applicants: Ravishankar Palaniswamy, Irving, TX (US); Sakthivael Kandaswaamy, Irving, TX (US); Parker Roan, Irving, TX (US)

(72) Inventors: Ravishankar Palaniswamy, Irving, TX (US); Sakthivael Kandaswaamy, Irving, TX (US); Parker Roan, Irving, TX (US)

(21) Appl. No.: 18/831,417

(22) Filed: Nov. 17, 2021

(51) Int. Cl. G08G 1/14; G05D 1/689; G05D 105/80; G05D 107/13; G05D 109/20; G05D 109/40; G06V 10/764; G06V 10/774; G06V 10/82; G06V 20/17; G06V 20/52; G08G 1/04

(52) U.S. Cl. CPC G08G 1/141; G05D 1/689; G06V 10/774; G06V 10/82; G06V 20/17; G06V 20/52; G08G 1/04; G05D 2105/80; G05D 2107/13; G05D 2109/20; G05D 2109/40; G06V 10/764; G06V 2201/08

(57) ABSTRACT

A method for determining parking occupancy with an unmanned aerial vehicle (UAV), is disclosed. The method includes monitoring a parking area comprising one or more parking spaces. The method includes collecting one or more multimedia images from the UAV, of the parking area. The method includes sending the one or more multimedia images to one or more image stations, wherein the one or more image stations configured to send the one or more multimedia messages to one or more detection servers. The method includes predicting via the one or more detection servers an occupancy of the parking area; configured to perform object detection. The method includes publishing a prediction from the one or more detection servers to one or more UEs of one or more users.

### REFERENCES TO RELATED APPLICATIONS

This application claims priority to U.S. Provisional Patent Application No. 63/124,965 entitled, “Parking guidance solution using unmanned aerial systems, AI, and deep learning network”, and filed on Dec. 14, 2020. This application is incorporated herein by reference.

### FIELD OF THE INVENTION

This disclosure relates to unmanned aerial vehicles (UAV) assisted systems for determining parking occupancy.

### BACKGROUND

Drivers are often tasked with finding parking in crowded parking lots or parking areas when traveling to an event, to work, to shop or just residing in heavily populated areas. And often, they are expected to find a parking space without guidance, or knowledge of where open parking spots are located, and how many spots are available. Having this information would allow a driver to locate where the easiest place to park would be or the closest place to park relative to their final destination. Current systems are limited in the fact that the data provided to driver's is not space specific, and often does not provide the most accurate guidance to open parking spots in a parking area. Additionally, to determine space specific occupancy information, sensors would have to be installed in every space or cameras would have to be installed in multiple locations on the lot causing increased construction, hardware and maintenance costs. Therefore, it is desirable to provide a method for sensing and determining parking occupancy, and to overcome the challenges faced by drivers in search for open parking spots. As such, drivers and parking lot owners can benefit from a cost-effective system that provides means for efficient parking, direct communication, and real time parking identification.

Accordingly, embodiments of the invention, provide significant advantages while overcoming the above-described and other disadvantages, as will now be described.

### SUMMARY

Several embodiments for determining parking occupancy are described herein. In one representative embodiment, a method for determining parking occupancy with an unmanned aerial vehicle (UAV), is disclosed. The method includes monitoring one or more parking lots (areas) with each comprising one or more parking spaces. The method includes collecting one or more multimedia images from the UAV, of the parking area. The method includes sending the one or more multimedia images to one or more image stations. The one or more image stations are configured to send the one or more multimedia messages to one or more detection servers. The method includes predicting using Artificial Intelligence (AI) on the one or more detection servers an occupancy of the parking area; configured to perform object detection. The method includes publishing a prediction from the one or more detection servers to one or more user equipment (UEs) of one or more users.

In one embodiment, the parking area comprises of one or more of a single parking space, a plurality of parking spaces, a parking lot or a parking facility.

In one embodiment, the method includes continuous or intermittent collection of multimedia images from the UAV, and determining from the multimedia images one or more available parking spaces in the parking area, or an overall occupancy of the entire parking area.

In one embodiment, the method includes processing the one or more multimedia images via a convolutional neural network (CNN) or a deep learning network (collectively referred to as AI) to identify one or more vehicles, or one or more objects in the one or more multimedia images.

In one embodiment, the method includes publishing the prediction from the one or more detection servers to one or more digital signs or one or more mobile applications.

In another exemplary embodiment, an unmanned aerial vehicle (UAV) system for determining parking occupancy is disclosed. The system includes one or more unmanned vehicles (UAVs) and one or more image stations (IS). The IS are configured to receive data comprising one or more multimedia images from the one or more UAVs of an assigned parking area. The IS is further configured to send the data to one or more detection servers configured to perform object detection. The detection servers are further configured to generate vehicle detection results from the data that includes a prediction of a vehicle in a multimedia image. The system further includes a network configured to send the vehicle detection results to a memory. Accordingly, the vehicle detection results are published to one or more user equipment(s) (UEs), where the system can further notify a user of the one or more UEs with a set of parking results.

In one embodiment, the one or more detection servers comprises of occupancy detection in one or more cloud servers (DCS), the DCS configured to generate AI occupancy results.

In one embodiment, the one or more detection servers comprises an occupancy detection in a local server or servers (DLS) configured to perform occupancy detection using artificial intelligence (AI) located at or near the parking area to generate AI occupancy results.

In one embodiment, the generated vehicle detection result comprises of object detection data analyzed to identify one or more vehicles.

In one embodiment, the published vehicle detection results are published by a cloud application programming interface (API) or a local API.

In one embodiment, the API adds business rules to the published vehicle detection results.

In one embodiment, the one or more detection servers are configured to receive training data from the one or more UAVs. The one or more detection servers are also configured to create one or more models that processes the training data, the one or more models identifying and classifying one or more objects. The one or more detection servers are configured to receive additional data including additional multimedia images. The one or more detection servers are configured to parsing the additional data to detect one or more objects in the parking area. The one or more detection servers are configured to predict vehicles via a prediction module, based on the training data and the additional data. The one or more detection servers are configured to send the prediction from the prediction module to be stored in a memory.

In one embodiment, the detection module can include a deep learning predictor module or convolutional neural network (CNN).

In one embodiment, the parking results comprises of a number or percentage of parking spots available in the parking area, a geographical location of the number of parking spots available, navigation to the location of one or more of the available parking spots.

In one embodiment, the UAV is configured to communicate wirelessly or via a local area network (LAN) connection to the one or more image stations.

In one embodiment, the wireless communication is one or more of a wireless connection, wireless fidelity, a radio frequency, or a short-range wireless technology.

In one embodiment, the one or more multimedia images comprises of pictures or video streams.

In one embodiment, the UAVs are one or more drones, a satellite, a balloon or a helicopter, or a similar flying object.

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of an interchangeable double-sided attachment for an article. This description includes drawings, wherein:

FIG. 1 depicts a system comprising the functional components of the parking guidance system, in accordance with an example;

FIG. 2 depicts a system architecture of the parking guidance system, in accordance with an example;

FIG. 3 depicts a functional block diagram of a system of networks, in accordance with an example;

FIG. 4 depicts a plurality of functional components of the parking guidance system, in accordance with an example; and

FIG. 5 depicts a flowchart depicting the process of identification of available parking spaces, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

An unmanned aerial vehicle (UAV) system for determining parking occupancy is disclosed. The system includes one or more unmanned vehicles (UAVs) and one or more image stations (IS). The Is is configured to receive data comprising one or more multimedia images from the one or more UAVs of an assigned parking area. The multimedia images include pictures or videos that are taken by one or more UAVs. Each UAV can be configured to be in communication with a plurality of other UAVs in a single or nested unmanned aerial system. The UAVs can include but are not limited to drones and satellites that are can hover above a designated area to capture aerial images. In particular, the UAVs can be used to determine the occupancy of a particular parking area, that can include one or more parking spaces, a plurality of parking spaces or occupancy of an entire parking facility or an entire street.

Accordingly, the UAV is programmed or remotely piloted to fly over a region covering a parking lot, a parking facility, or a zone of parking spaces in the region. As the UAV is flying over the region, the UAV can be programmed to capture a plurality of images or videos periodically or based on a predetermined time period. The UAV is in communication with one or more base stations that are configured to transmit the multimedia to one or more detection servers. The detection servers are configured to perform object detection in accordance with the multimedia images as received. Based on one or more objects that are detected, the UAVs are effectively used to determine the occupancy of the designated parking lot, or used to determine an overall occupancy of a larger parking region.

Accordingly, the occupancy is determined by the one or more detection servers via software program that utilizes a convolutional neural network (CNN) or a deep learning network that is utilized to identify vehicles or other objects in the multimedia. In some embodiments, the detection servers can be configured to focus on specific regions of an entire region designated for the UAV, that represent individual parking spaces or a plurality of parking spaces. Based on the detected objects, a parking occupancy status can be generated that establishes how many spaces in the total area, and which specific spaces are available for incoming vehicles to park in a parking area.

In order to prepare the CNN or deep learning network, the system can be trained through an introduction of images and videos from UAVs. These images can include an empty parking area or region of interest in order to create a baseline of comparison for the system prior to occupancy fluctuations caused by a plurality of cars entering or leaving the parking region. After the initial identification training, the CNN or deep learning network will not require any previous images or videos for reference to determine occupancy and will effectively be able to determine occupancy without any previous data for a user defined or undefined region.

The Cloud Servers are further configured to generate vehicle detection results from the data that includes a prediction of parking availability. Based on the number of vehicles detected, relative to the baseline comparison, or a predetermined occupancy. After the occupancy detection is completed, the resulting data including the vehicle detection results are stored in a storage device that includes virtual storage or local storage, to be prepared for publishing. Accordingly, the vehicle detection results are published to one or more user equipment (UEs), where the system can further notify a user of the one or more UEs with a set of parking results. In addition. The vehicle detection results can also be published directly or indirectly to signage, a mobile application, or a web application, each of which are configured for parking guidance, and statistical analysis.

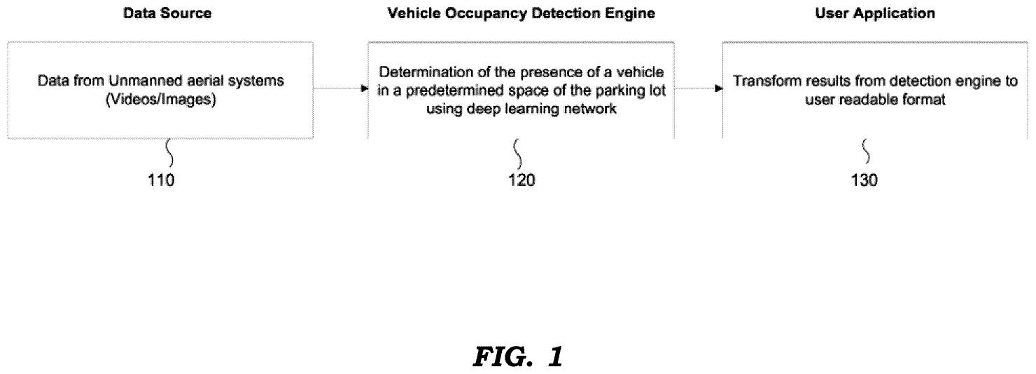

FIG. 1 depicts a system comprising the functional components of the parking guidance system. The parking guidance system can include a data source that receives multimedia data from one or more unmanned aerial vehicles 110. The aerial vehicles are configured to capture multimedia images such as video or picture images and submit them to a vehicle occupancy detection engine 120. The vehicle occupancy detection engine is configured to make a determination of one or more vehicles in a predetermined space of the parking lot. The determination can be made using a deep learning network, that is configured to utilize past history, and prior learned data to decide of whether parking spaces could be available. The determination will be based on one or more stamps of previously taken multimedia data or images. The vehicle occupancy detection engine 120 is then configured to prepare for transmission, the determination to a user application 130. The user application 130 is configured to transform the determination determined by the vehicle occupancy detection engine 120, to user-readable format.

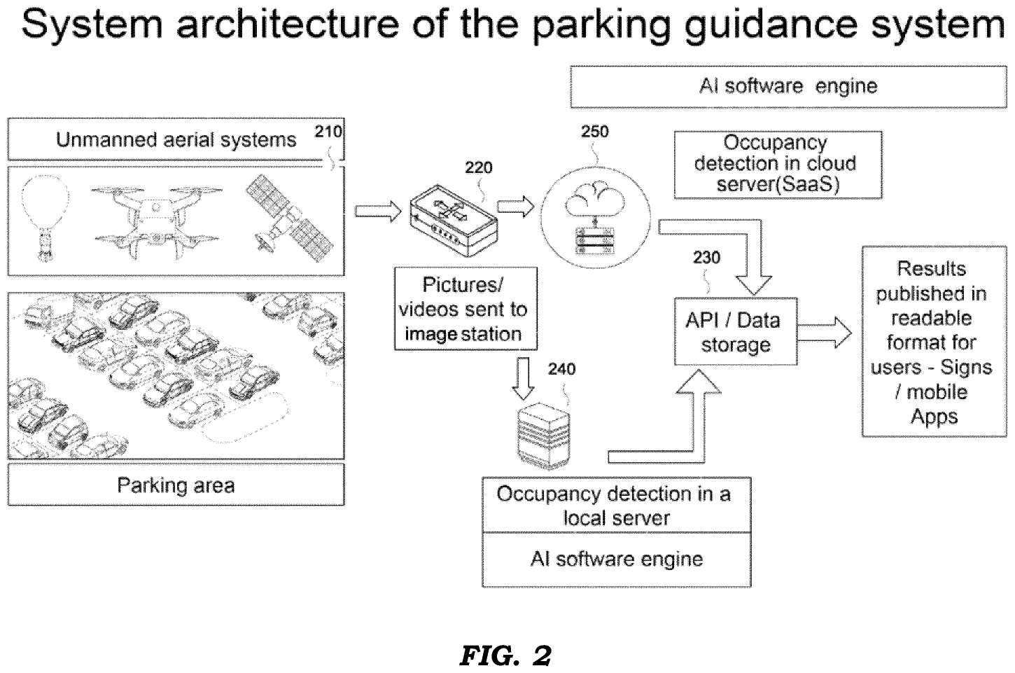

FIG. 2 depicts a system architecture 200 of the parking guidance system. The system architecture 200 is configured to receive data from an unmanned aerial vehicle 210. The unmanned aerial system 210 is configured to communicate via a wireless connection with an image station 220. The unmanned aerial vehicle (UAV) can be assigned to a parking area, a parking structure, or another area designated for the storage/parking of vehicles, to monitor occupancy of the respective parking areas. Accordingly, the UAV 210 is configured to send pictures and videos that are captured manually, autonomously, or during predetermined time periods, that capture the status of the parking area during certain periods of the day. As the pictures or video are taken, the UAV 210 transmits the pictures and video to image station 220. The image station 220 is configured to transmit the multimedia images to an occupancy detection local server 240. The local server 240 is configured to implement artificial intelligence (AI) software engine, that is configured to use machine learning for parking occupancy determinations using one or more-time stamps of the multimedia images that are captured. Alternatively, a cloud server 250 can be utilized to perform occupancy detection. The occupancy detection results from the cloud server 250 or the local server 240 are transmitted to a storage system 230, from where it is pushed to a publisher module that is configured to publish the results in a readable format for users to access on one or more user equipment devices.

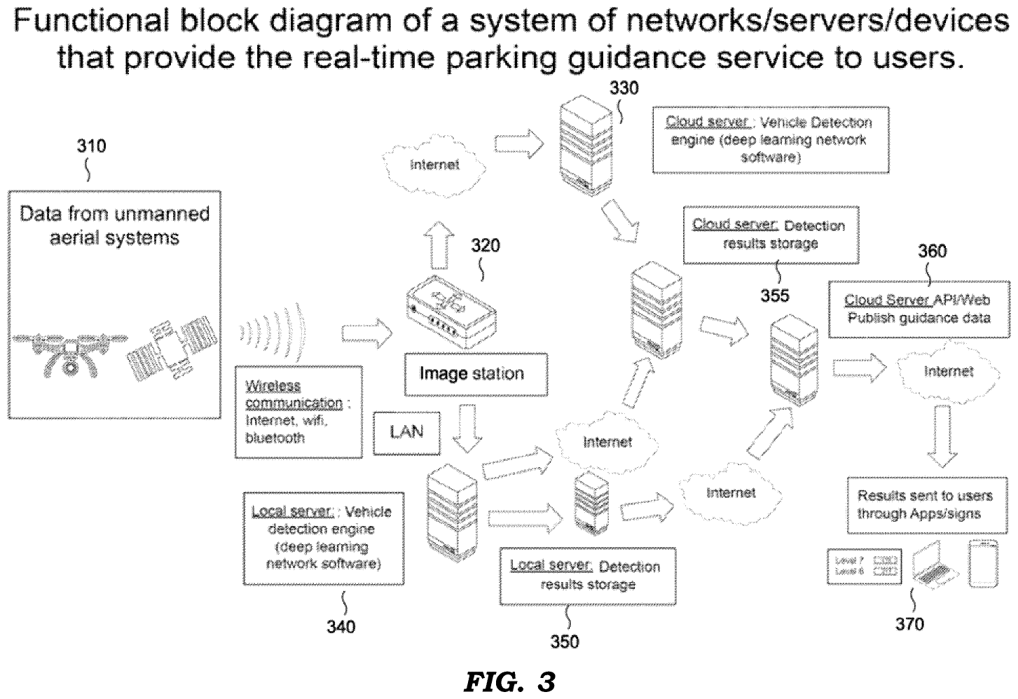

FIG. 3 depicts a functional block diagram of a system of networks. The system architecture 300 is configured to receive data from an unmanned aerial system 310. The unmanned aerial system can be one or more drones, an aerial vehicle, a satellite, a large balloon, or an airplane that has an aerial route over a parking area. The aerial vehicle is configured to communicate via a wireless connection with an image station 320. The wireless connection can be implemented via an internet, Wi-Fi, or short-wave wireless connectivity. The image station is configured to communicate with a cloud server 330 or a local server 340. In the instance where e the image station 320 communicates with the local server 340, the local server 340 implements a vehicle detection engine that utilizes a deep learning network software. The vehicle detection engine can make a determination of whether there is availability in the parking area, and transmit the results to the local server database 350. The local server 340 is then able to transmit the results to publishing cloud server 360 for transmission to one or more computing devices or UEs 370. Alternatively, the cloud server 330 is configured to receive the aerial data information from the image station, and transmit the data via the cloud server 350 to a detection results cloud server 355, configured to then transmit the aerial data information to one or more computing devices or UEs 370.

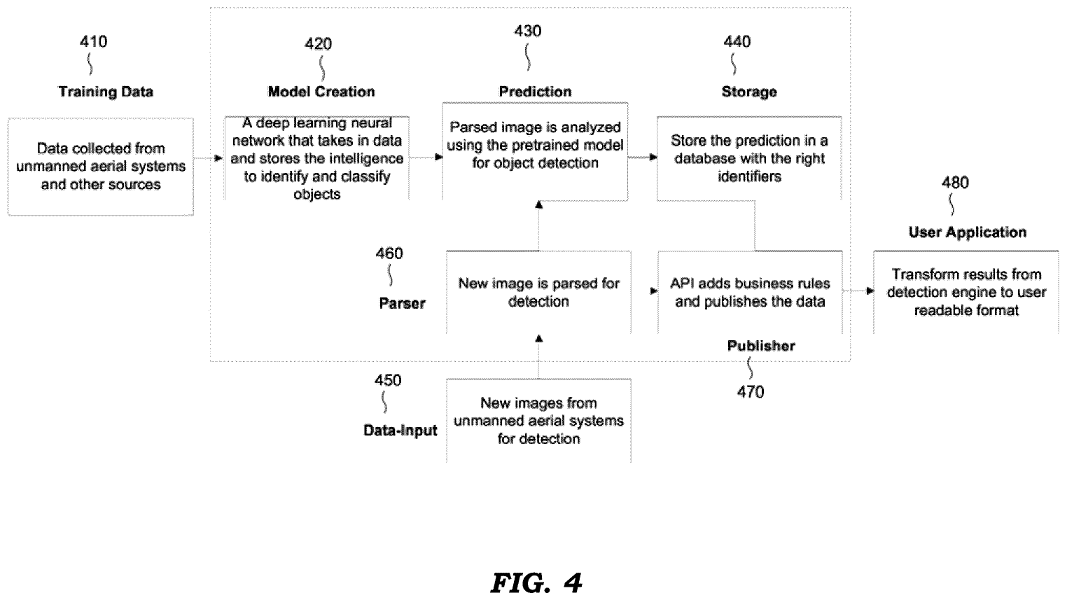

FIG. 4 depicts a plurality of functional components of the parking guidance system. The functional components first include a training data module 410. The training data module is configured to make a determination of the presence of a vehicle in a predetermined space. The determination is made via deep learning or a convolutional neural network. The training data module 410 is configured to transmit the determination to the model creation module 420. The model creation module 420 is configured to receive the data from the UAV, including the videos and images, to create a model of the parking area by using a deep learning neural network that takes in data and stores the intelligence to identify and classify objects in the parking area. The model data is then transmitted to the prediction module 430. The prediction module is configured to parse an image and analyze the image via the pre-trained model for object detection. The parsed image that is input into the prediction module 430, can be new images or stored images from the UAV that are parsed and then transmitted into the prediction module from the data input modules 450 and the parsing module 460 respectively. The prediction module 430 is configured to submit the parsed data and the associated prediction into a storage 440. The storage 440 is configured to store the prediction in a database with one or more identifiers that identifies the parking area's occupancy. The storage 440 transmits the prediction into a publisher module 470. The publisher module is configured to utilize an application programming interface (API) to add business rules to the prediction in preparation for publishing. The publishing module 470 transmits the published data to a user application 480. The user application 480 is configured to transform the results into a readable format that is viewable on a user equipment.

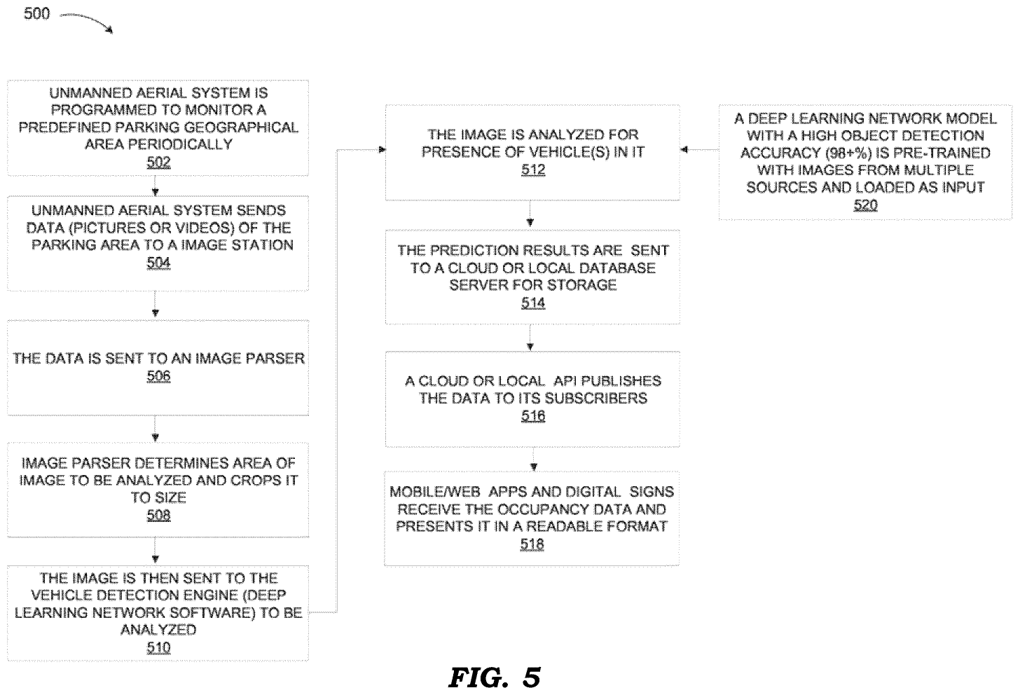

FIG. 5 depicts a flowchart depicting the process of identification of available parking spaces. In a first step, an unmanned aerial system is programmed to monitor a predefined geographical area periodically 502. The unmanned aerial system then sends data, comprising pictures and videos, of the parking area to the image station 504. The data is then sent to an image parser 506. The image parser is configured to determine the area of the image to be analyzed and crops it to the size necessary to be transmitted for analysis 508. The image is then sent to the vehicle detection engine, utilizing a deep learning network software, for analysis 510. The image is then analyzed for the presence of vehicles, to develop a prediction 512. The prediction results are sent over to a cloud or local server network, to be stored in preparation for transmission 514. The cloud or local server transmits the prediction results for publishing via an API accessed by a plurality of subscribers 516. The published results are subsequently published to one or more mobile or web-based applications that are configured to receive occupancy data to be presented in a readable format for user accessibility 518. The published results are derived from a deep learning network model that is configured with a high object detection accuracy of 98% or more 520. The deep learning network model is configured to be pre-trained with images from multiple sources and load the image for analysis in the prediction module 512.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes, and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A method for determining parking occupancy with an unmanned aerial vehicle (UAV), the method including the steps of:
monitoring a parking area comprising one or more parking spaces;
collecting one or more multimedia images from the UAV, of the parking area;
sending the one or more multimedia images to one or more image stations, wherein the one or more image stations configured to send the one or more multimedia messages to one or more detection servers;
predicting via the one or more detection servers an occupancy of the parking area; configured to perform object detection;
publishing a prediction from the one or more detection servers one or more user equipment (UEs) of one or more users.

2. The method of claim 1, wherein the parking area comprises of one or more of:
a single parking space;
a plurality of parking spaces;
a parking lot;
a street;
a parking garage rooftop; or
a parking facility.

3. The method of claim 1, further including the steps of:
continuously or intermittently collecting multimedia images from the UAV;
determining from the multimedia images one or more available parking spaces in the parking area, or an overall occupancy of the parking area.

4. The method of claim 1, further including the steps of:
processing the one or more multimedia images with a convolutional neural network (CNN) or a deep learning network to identify one or more vehicles, or one or more objects in the one or more multimedia images.

5. The method of claim 1, further including the step of:
publishing the prediction from the one or more detection servers to one or more digital signs or one or more mobile applications.

6. An unmanned aerial vehicle (UAV) system for determining parking occupancy comprising:
one or more unmanned vehicles (UAVs);
one or more image stations configured to:
receive data comprising one or more multimedia images from the one or more UAVs of an assigned parking area;
sending the data to one or more detection servers configured to perform object detection;
generate vehicle detection results from the data that includes a prediction of parking availability; and
a network configured to:
send the vehicle detection results to a memory;
publish the vehicle detection results to one or more user equipment (UEs); and
notify a user of the one or more UEs with a set of parking results.

7. The UAV system of claim 6, wherein the one or more detection servers comprises of an occupancy detection method in cloud server (DCS) with artificial intelligence (AI), the DCS configured to generate AI occupancy prediction results.

8. The UAV system of claim 6, wherein the one or more detection servers comprises an occupancy detection local server configured to perform occupancy detection in or near the parking lot with artificial intelligence (AI), the AI configured to generate AI occupancy results.

9. The UAV system of claim 6, wherein the generated vehicle detection result comprises of object detection data analyzed to identify one or more vehicles.

10. The UAV system of claim 6, wherein the one or more UVAs are configured to continuously send data to the one or more detection servers to produce real-time results.

11. The UAV system of claim 6, wherein the published vehicle detection results are published by a cloud application programming interface (API) or local API.

12. The UAV system of claim 11, wherein the API adds business rules to the published vehicle detection results.

13. The UAV system of claim 6, wherein the one or more detection servers are configured to:
receive training data from the one or more UAVs;
create one or more models that processes the training data, the one or more models identifying and classifying one or more objects;
receive additional data including additional multimedia images;
parsing the additional data to detect one or more objects in the parking area;
predicting via a prediction module, occupancy data based on the training data and the additional data; and
store the prediction from the prediction module in the memory.

14. The UAV system of claim 13, wherein detection module can include a deep learning software engine or convolutional neural network (CNN).

15. The UAV system of claim 6, wherein the parking results comprises of:
a number of parking spots available in the parking area;
a location of the number of parking spots available; and
navigation to the location of one or more of the parking spots available.

16. The UAV system of claim 6, wherein the UAV is configured to communicate wirelessly or via a local area network (LAN) connection to the one or more image stations.

17. The UAV system of claim 6, wherein the wireless communication is one or more of a wireless connection, wireless fidelity, a radio frequency, or a short-range wireless technology.

18. The UAV system of claim 6, wherein the one or more multimedia images comprises of pictures or video images.

19. The UAV system of claim 6, wherein the UAVs are one or more of a drone, a satellite, or a helicopter, or a similar object.
